(19) United States
(12) Patent Application Publication
(10) Pub. No.: US 2023/0302807 A1
(43) Pub. Date: Sep. 28, 2023

(54) LIQUID SUPPLY DEVICE AND LIQUID SUPPLY SYSTEM

(71) Applicant: SEIKO EPSON CORPORATION, Tokyo (JP)

(72) Inventors: Kiyoteru KATSUKI, Azumino-shi (JP); Yoshiharu MIZUNO, Matsumoto-shi (JP)

(73) Assignee: SEIKO EPSON CORPORATION, Tokyo (JP)

(21) Appl. No.: 18/125,831

(22) Filed: Mar. 24, 2023

(30) Foreign Application Priority Data
Mar. 25, 2022 (JP) 2022-049469

(51) Int. Cl. B41J 2/175

(52) U.S. Cl. CPC B41J 2/17523; B41J 2/17566; B41J 2002/17569

(57) ABSTRACT

A liquid supply device includes a first liquid supply path that supplies ink to a first liquid supply port corresponding to a cartridge, a second liquid supply path that supplies ink in a second liquid container to a second liquid supply port corresponding to a cartridge, a selector that selects either the first liquid supply path or the second liquid supply path, an on-off valve and a pump that, when the first liquid supply path is selected by the selector, supplies ink via the first liquid supply path to the cartridge, and an on-off valve and the pump that, when the second liquid supply path is selected by the selector, supplies ink via the second liquid supply path to the cartridge.

The present application is based on, and claims priority from JP Application Serial Number 2022-049469, filed Mar. 25, 2022, the disclosure of which is hereby incorporated by reference herein in its entirety.

### BACKGROUND

### 1. Technical Field

The present disclosure relates to a liquid supply device and a liquid supply system.

### 2. Related Art

Printers that perform printing on media by ejecting printing liquids such as ink have been known. For example, as demonstrated in JP-A-2004-303102, a device that provides an appropriate ink cartridge corresponding to a printer model by reading, from an ID card, the type of the ink cartridge serving as a container of a printing liquid has been disclosed.

However, with the existing device as mentioned above, which may provide a container itself this described above, it is hard to use a container as a refill container.

### SUMMARY

According to an aspect of the present disclosure, a liquid supply device includes a first liquid supply path that supplies a printing liquid contained in a first liquid container to a first liquid supply port corresponding to a type of a container, a second liquid supply path that supplies a printing liquid contained in a second liquid container to a second liquid supply port corresponding to a type of the container, a selector that selects either the first liquid supply path or the second liquid supply path, and a liquid supplier that, when the first liquid supply path is selected by the selector, supplies the printing liquid contained in the first liquid container via the first liquid supply path to the container and that, when the second liquid supply path is selected by the selector, supplies the printing liquid contained in the second liquid container via the second liquid supply path to the container.

According to another aspect of the present disclosure, a liquid supply system includes a first liquid supply path that supplies a printing liquid contained in a first liquid container to a first liquid supply port corresponding to a type of a container, a second liquid supply path that supplies a printing liquid contained in a second liquid container to a second liquid supply port corresponding to a type of the container, a selector that selects either the first liquid supply path or the second liquid supply path, a liquid supplier that, when the first liquid supply path is selected by the selector, supplies the printing liquid contained in the first liquid container via the first liquid supply path to the container and that, when the second liquid supply path is selected by the selector, supplies the printing liquid contained in the second liquid container via the second liquid supply path to the container, a first detector that detects a storage amount of the printing liquid capable of being supplied via the first liquid supply path from the first liquid container, a second detector that detects a storage amount of the printing liquid capable of being supplied via the second liquid supply path from the second liquid container, a determiner that determines whether the storage amount of the printing liquid capable of being supplied via the first liquid supply path from the first liquid container is less than or equal to a predetermined lower limit, and that determines whether the storage amount of the printing liquid capable of being supplied via the second liquid supply path from the second liquid container is less than or equal to the predetermined lower limit, and a notifier that issues, based on a determination result of the determiner, a notification indicating either that the storage amount of printing liquid capable of being supplied via the first liquid supply path from the first liquid container is less than or equal to the predetermined lower limit or that the storage amount of print liquid capable of being supplied via the second liquid supply path from the second liquid container is less than or equal to the predetermined lower limit.

### BRIEF DESCRIPTION OF THE DRAWINGS

FIG. 1 is a diagram illustrating an example of a configuration of a liquid supply system.

FIG. 2 is a block diagram illustrating an example of an electrical configuration of the liquid supply system.

FIG. 3 is a pictorial representation illustrating an example of a notification issued by a notifier.

FIG. 4 is a flowchart illustrating an example of operations of a liquid supply system according to an embodiment.

FIG. 5 is a flowchart illustrating an example of operations of the liquid supply system according to the embodiment.

FIG. 6 is a table illustrating an example of content of refill history information.

FIG. 7 is a flowchart illustrating an example of operations of a liquid supply system according to a second embodiment.

FIG. 8 is a flowchart illustrating an example of operations of a liquid supply system according to a third embodiment.

FIG. 9 is a table illustrating an example of content of refill history information.

FIG. 10 is a diagram illustrating another example of the configuration of the liquid supply device.

FIG. 11 is a diagram illustrating another example of the configuration of the liquid supply device.

### DESCRIPTION OF EXEMPLARY EMBODIMENTS

### First Embodiment

An embodiment of a liquid supply device and a liquid supply system will be described hereafter with reference to the accompanying drawings.

### Configuration of Liquid Supply System 1

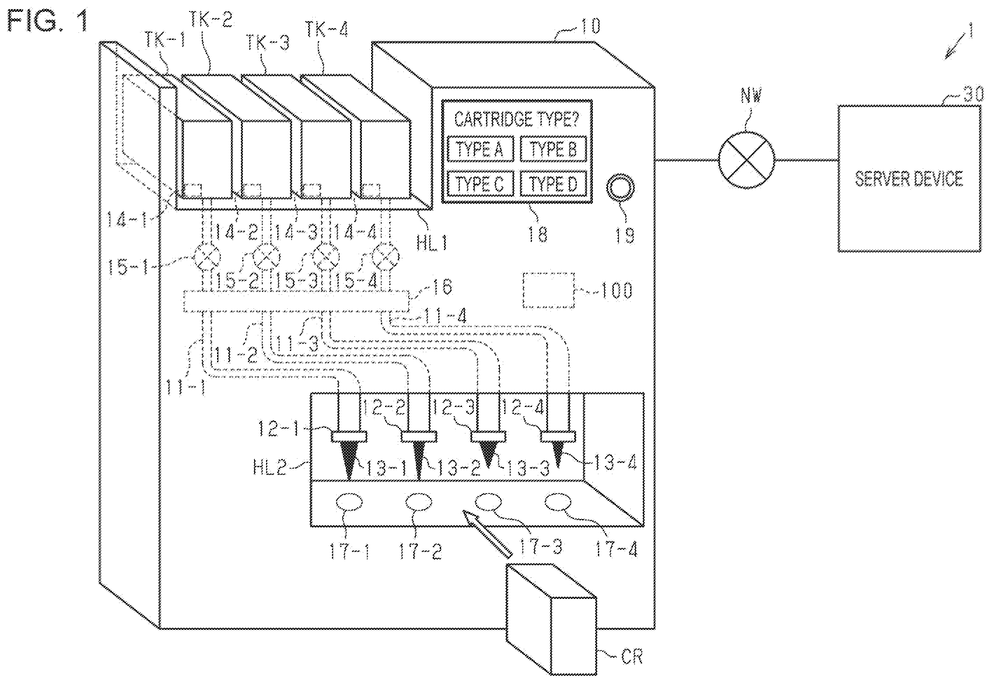

As illustrated in FIG. 1, a liquid supply system 1 includes, for example, one or more liquid supply devices 10 and a server device 30. Hereafter, a description will be given of the case where the liquid supply system 1 includes a single liquid supply device 10. The liquid supply device 10 and the server device 30 are, for example, connected to each other via a network NW so as to be capable of transmitting and receiving information. The liquid supply device 10 and the server device 30 perform communication, for example, wirelessly or in a wired manner. In the wireless communication, the network NW is implemented by near-field communication such as Wi-Fi (registered trademark) or Bluetooth (registered trademark). In addition, the network NW may be the Internet, a wide area network (WAN), a local area network (LAN), a provider terminal, a wireless communication network, wireless base station, a leased line, or the like.

The liquid supply device 10 is a device that supplies ink, which is an exemplary printing liquid, to a cartridge CR, which is an exemplary container. The liquid supply device 10 has, for example, a rectangular parallelepiped shape and is provided with an opening HL1 at the top. In the opening HL1, liquid containers TK, which contain ink that the liquid supply device 10 supplies to the cartridge CR, are located. Hereafter, a description will be given of the case where the ink supplied to the cartridge CR to be handled by the liquid supply device 10 is four types of ink, a first ink to a fourth ink. At the top of the liquid supply device 10, arming members (not illustrated) the number of which corresponds to the number of types of ink that are able to be supplied by the liquid supply device 10 are disposed, and thus the liquid containers TK are removable from the liquid supply device 10.

Hereafter, a description will be given such that, among the components included in the liquid supply device 10, components related to the first ink are denoted by reference numerals appended with the hyphenated numeral “-1”, components related to the second ink are denoted by reference numerals appended with a hyphenated numeral “-2”, components related to the third ink are denoted by reference numerals appended with a hyphenated numeral “-3”, and components related to the fourth ink are denoted by reference numerals appended with a hyphenated numeral “-4”. In addition, hereafter, when the components included in the liquid supply device 10 are not discriminated from each other regardless of the type of ink, the hyphenated numerals are omitted. In the present embodiment, four liquid containers TK, liquid containers TK-1 to TK-4, which correspond to the four types of ink, are located in the opening HL1. It is assumed hereafter that the liquid container TK-1 is an example of a first liquid container and the liquid container TK-2 is an example of a second liquid container.

The liquid supply device 10 includes, for example, liquid supply paths 11, detectors 14, on-off valves 15, a pump 16, lighting portions 17, a touch panel 18, an imager 19, and a controller 100. Specifically, the liquid supply device 10 includes liquid supply paths 11-1 to 11-4, detectors 14-1 to 14-4, on-off valves 15-1 to 15-4, and lighting portions 17-1 to 17-4 corresponding to the four types of ink.

The liquid supply path 11 is a path for supplying ink contained in the liquid containers TK to injecting portions 13 corresponding to the four types of ink. One upstream end of the liquid supply path 11 is coupled to the liquid container TK.

The liquid supply path 11 includes, for example, a coupling portion 12. The coupling portion 12 is, for example, disposed in an upper portion of an opening HL2 in the front of the liquid supply device 10. The coupling portion 12 couples the liquid supply path 11 to the injecting portion 13. That is, the other, downstream end of the liquid supply path 11 is coupled through the coupling portion 12 to the injecting portion 13.

The injecting portion 13 is a member for supplying a liquid to the cartridge CR. The injecting portion 13 may be, for example, an injection needle. The injecting portion 13 includes an injection coupling portion (not illustrated). The injection coupling portion is provided at a base end of the injecting portion 13. The injection coupling portion is capable of being coupled to the coupling portion 12. Thus, the injecting portion 13 is removable from the liquid supply device 10 by using the coupling portion 12. Specifically, the liquid supply path 11-1 is coupled through the coupling portion 12-1 to the injecting portion 13-1. The liquid supply path 11-2 is coupled through the coupling portion 12-2 to the injecting portion 13-2. The liquid supply path 11-3 is coupled through the coupling portion 12-3 to the injecting portion 13-3. The liquid supply path 11-4 is coupled through the coupling portion 12-4 to the injecting portion 13-4. The coupling portions 12-1 to 12-4 have, for example, the same shape. It is assumed hereafter that the liquid supply path 11-1 is an example of a first liquid supply path and the liquid supply path 11-2 is an example of a second liquid supply path. It is also assumed that the coupling portion 12-1 is an example of a first coupling portion and the coupling portion 12-2 is an example of a second coupling portion.

The injecting portions 13-1 to 13-4 correspond to the types of the cartridges CR to be handled by the liquid supply device 10. Here, the first to fourth inks are inks supplied by business operators different from each other who provide the cartridges CR themselves and devices using the cartridges CR. In addition, the first to fourth inks are those for use in products different from one another, such as printing devices. Therefore, the cartridges CR to be handled by the liquid supply device 10 may differ from each other, in accordance with the type of ink, in the shape of the cartridge CR itself, the shape of the ink inlet of the cartridge CR, or the shape of packing provided at the ink inlet of the cartridge CR. Business operators who provide the cartridges CR themselves and devices using the cartridges CR are referred to as cartridge providers.

The injecting portion 13 includes a distal end (not illustrated). The distal end of the injecting portion 13 is located at an edge of the injecting portion 13. The distal end of the injecting portion 13 differs in shape in accordance with the type of the cartridge CR. In particular, the distal end of the injecting portion 13 has a shape that corresponds to the shape of the inlet of the cartridge CR and the shape of the packing provided at the inlet of the cartridge CR. Specifically, the distal end of the injecting portion 13-1 has, for example, a shape corresponding to the shape of the cartridge CR that contains the first ink. The distal end of the injecting portion 13-2 has, for example, a shape corresponding to that of the cartridge CR that contains the second ink. The distal end of the injecting portion 13-3 has, for example, a shape corresponding to the shape of the cartridge CR that contains the third ink. The distal end of the injecting portion 13-4 has, for example, a shape corresponding to the shape of the cartridge CR that contains the fourth ink.

The injecting portion 13 includes an injection path (not illustrated). The injection path includes a first communication port and a second communication port (not illustrated). The first communication port is provided at a proximal end of the injecting portion 13 in the injection path. The first communication port is capable of being coupled at the coupling portion 12 to the liquid supply path 11. The second communication port is provided at an edge of the injecting portion 13 in the injection path. The second communication port is capable of being coupled to the inlet of the cartridge CR.

In such a manner, the liquid supply path 11 communicates with the second communication port via the injection path. That is, the liquid supply paths 11 may be described as paths for supplying ink contained in the liquid containers TK to the second communication ports corresponding to the four types of ink. It is assumed hereafter that the second communication port of the injecting portion 13 is an example of a liquid supply port. Specifically, it is assumed that the second communication port of the injecting portion 13-1 is an example of a first liquid supply port and the second communication port of the injecting portion 13-2 is an example of a second liquid supply port.

The detector 14 detects the storage amount of ink capable of being supplied via the liquid supply path 11 from the liquid container TK. The detector 14 is, for example, implemented by a weight sensor. The detector 14 is attached at the bottom of the liquid container TK. The detector 14 detects the remaining amount of a liquid contained in the liquid container TK by detecting the weight of the liquid container TK. Specifically, the detector 14-1 detects the storage amount of ink capable of being supplied via the liquid supply path 11-1 from the liquid container TK-1. The detector 14-2 detects the storage amount of ink capable of being supplied via the liquid supply path 11-2 from the liquid container TK-2. The detector 14-3 detects the storage amount of ink capable of being supplied via the liquid supply path 11-3 from the liquid container TK-3. The detector 14-4 detects the storage amount of ink capable of being supplied via the liquid supply path 11-4 from the liquid container TK-4. The detector 14 outputs information indicating the detected storage amount of ink to the controller 100. Hereafter, it is assumed that the detector 14-1 is an example of a first detector and the detector 14-2 is an example of a second detector.

The on-off valve 15 is provided in each of the liquid supply paths 11. Specifically, the on-off valve 15-1 is provided in the liquid supply path 11-1, the on-off valve 15-2 is provided in the liquid supply path 11-2, the on-off valve 15-3 is provided in the liquid supply path 11-3, and the on-off valve 15-4 is provided in the liquid supply path 11-4. The on-off valve 15 opens or closes the liquid supply path 11 by opening or closing based on control of the controller 100. The on-off valve 15 usually closes the liquid supply path 11.

The pump 16 is provided across the liquid supply paths 11-1 to 11-4. The pump 16 operates based on control of the controller 100. In the example illustrated in FIG. 1, the pump 16 is downstream of the on-off valve 15. The controller 100 controls the on-off valve 15 and the pump 16, for example, to supply ink from the liquid container TK to the injecting portion 13 via the liquid supply path 11 related to, among the on-off valves 15-1 to 15-4, an opened on-off valve 15. In supplying ink, the controller 100 opens one on-off valve 15 among the on-off valves 15-1 to 15-4. A combination of the on-off valve 15 and the pump 16 is an example of a liquid supplier.

The lighting portion 17 turns on or off based on control of the controller 100. The lighting portion 17 is, for example, implemented by a light-emitting diode (LED). The lighting portions 17 are, for example, provided in the vicinities of the corresponding injecting portions 13. Specifically, the lighting portion 17-1 is provided in the vicinity of the injecting portion 13-1, the lighting portion 17-2 is provided in the vicinity of the injecting portion 13-2, the lighting portion 17-3 is provided in the vicinity of the injecting portion 13-3, and the lighting portion 17-4 is provided in the vicinity of the injecting portion 13-4. Regarding the lighting portions 17, in supplying ink, among the lighting portions 17-1 to 17-4, the lighting portion 17 provided in the vicinity of the injecting portion 13 to which ink is to be supplied turns on. Thereby, the lighting portion 17 notifies the user of the injecting portion 13 to which ink is to be supplied.

The touch panel 18 is, for example, constructed integrally with a display unit such as a display. The touch panel 18 displays various types of information based on control of the controller 100. In addition, the touch panel 18 receives an operation of the user. The touch panel 18 displays, for example, an image that prompts the user to select the type of the cartridge CR for use as a refill container. The touch panel 18 receives, for example, an operation of the user in accordance with the displayed image. The touch panel 18 outputs information indicating the received operation of the user to the controller 100. In processing of displaying various types of information, the touch panel 18 is an example of a notifier, and, in processing of receiving operations of the user, the touch panel 18 is an example of an operation unit.

The imager 19 captures an imaging object to generate an image. The imager 19 is, for example, disposed at the front of the liquid supply device 10 and captures the cartridge CR to generate an image. The imager 19 outputs information indicating the generated image to the controller 100.

The controller 100, for example, controls components included in the liquid supply device 10. The operations of the controller 100 will be described below in more detail.

The server device 30, for example, notifies that the storage amount of ink capable of being supplied via the liquid supply path 11 from the liquid container TK is less than or equal to a predetermined lower limit, based on information received via the network NW from the liquid supply device 10. Upon receiving a notification issued by the server device 30, a business operator who is in charge of refilling the liquid supply device 10 with ink refills the liquid container TK with ink. The business operator who is in charge of refilling the liquid supply device 10 with ink will be described as an ink refill operator hereafter.

### Electrical Configuration of Liquid Supply System 1

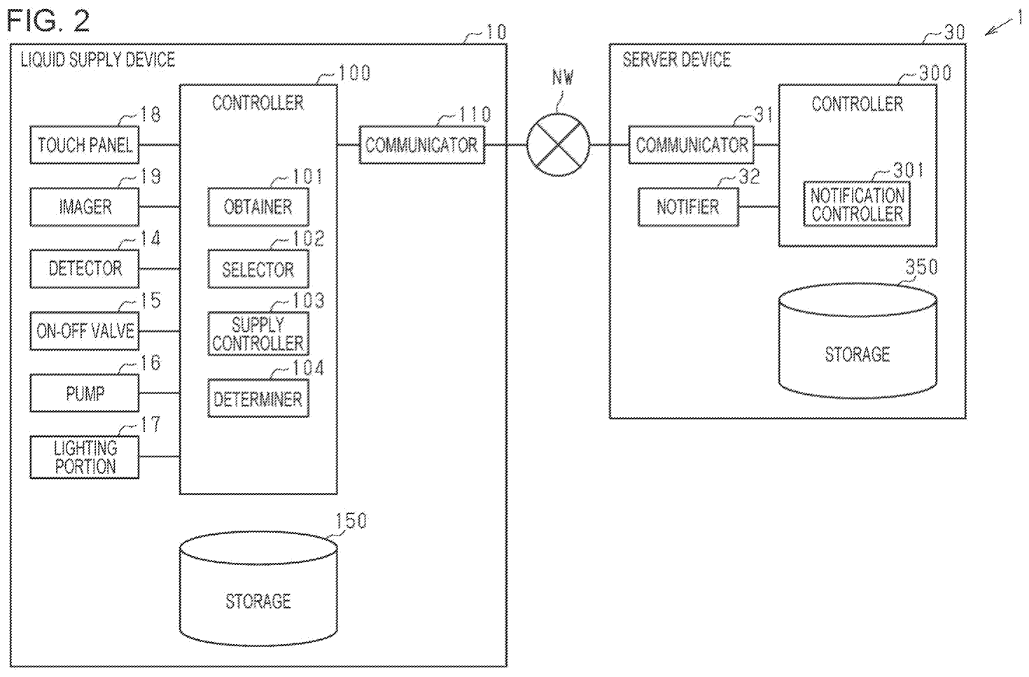

As illustrated in FIG. 2, the liquid supply device 10 includes the controller 100, a communicator 110, and a storage 150. The controller 100 is, for example, implemented by a hardware processor, such as a central processing unit (CPU), executing a program (software). In addition, some or all of these components may be implemented by hardware (including circuitry) such as large-scale integration (LSI), an application-specific integrated circuit (ASIC), a field-programmable gate array (FPGA), and a graphics processing unit (GPU), or may be implemented by software and hardware cooperating each other. The program may be stored in advance in the storage 150 including a non-transitory storage medium, such as a hard disk drive (HDD) or flash memory. The communicator 110 includes, for example, a communication circuit or a communication module and transmits and receives various types of information via the network NW from the server device 30.

The storage 150 may be implemented by various storage media mentioned above, or electrically erasable programmable read-only memory (EEPROM), read-only memory (ROM), random access memory (RAM) or the like.

The controller 100 includes, for example, an obtainer 101, a selector 102, a supply controller 103, and a determiner 104. The obtainer 101 obtains various types of information from the components included in the liquid supply device 10. Specifically, the obtainer 101 obtains information indicating the storage amount of ink detected by the detector 14. The obtainer 101 obtains information indicating operations of the user from the touch panel 18. The obtainer 101 obtains information indicating an image generated by the imager 19.

The selector 102 selects any one of the liquid supply paths 11. The selector 102 selects the liquid supply path 11, for example, based on information indicating an operation of the user input to the touch panel 18. Specifically, in accordance with an operation of selecting the type of the cartridge CR, the selector 102 selects the liquid supply path 11 corresponding to ink to be contained in the cartridge CR selected by the operation.

In addition, the selector 102 selects the liquid supply path 11 based on an image generated by the imager 19. Here, information indicating ink to be contained in the cartridge CR is added to the cartridge CR. The information indicating ink is, for example, a two-dimensional barcode. The selector 102 selects the liquid supply path 11 corresponding to ink to be contained in the cartridge CR by reading a two-dimensional barcode indicated in an image generated by the imager 19.

In accordance with a selection result of the selector 102, the supply controller 103 supplies ink via the selected liquid supply path 11 to the cartridge CR. Specifically, the supply controller 103 opens the on-off valve 15 in the liquid supply path 11 selected by the selector 102 and closes the other on-off valves 15. By operating the pump 16, the supply controller 103 supplies ink contained in the liquid container TK to the injecting portion 13 via the selected liquid supply path 11.

Here, the amounts of ink supplied by the supply controller 103 may be the same or may differ by the type of the cartridge CR. Hereafter, a description will be given of the case where the storage 150 stores control information indicating the control content, such as the amounts of ink supplied to the corresponding types of the cartridge CR. In this case, with reference to control information, the supply controller 103 supplies ink in an amount that corresponds to the selected cartridge CR. The control information stored in the storage 150 is updated in response to settings regarding a new cartridge CR or a change to the settings for the cartridges CR being made by a cartridge provider, an ink refill operator, or the like. Control information may be updated via the network NW or may be updated by a terminal device or the like coupled to the liquid supply device 10.

In addition, in accordance with a selection result of the selector 102, the supply controller 103 turns on the lighting portion 17 provided in the vicinity of the injecting portion 13 of the selected liquid supply path 11. Thereby, the user may install the cartridge CR in the injecting portion 13 corresponding to the cartridge CR.

The determiner 104 determines, based on a detection result of the detector 14, whether the storage amount of ink capable of being supplied via the liquid supply path 11 from the liquid container TK is less than or equal to a predetermined lower limit. Specifically, for a detection result of each detector 14, the determiner 104 determines whether the storage amount of ink capable of being supplied via the liquid supply path 11 from the liquid container TK is less than or equal to the predetermined lower limit. The predetermined lower limits in the first ink to the fourth ink may differ or may be the same. The predetermined lower limit may be determined in advance, may be determined by a cartridge provider, or may be determined by an ink refill operator.

The determiner 104 causes the communicator 110 to transmit information indicating a determination result to the server device 30. The information indicating a determination result includes, for example, a determination result and information indicating the type of ink related to the determination result. In this case, ink type information in which information indicating the type of ink that is supplied to the cartridge CR to be handled by the liquid supply device 10 and information indicating the liquid supply path 11 that supplies the ink are associated with each other is stored in the storage 150. The determiner 104 identifies, based on the ink type information, the type of ink related to the determination result. The ink type information is updated, for example, when ink that is supplied to the cartridge CR to be handled by the liquid supply device 10 is changed or updated.

As illustrated in FIG. 2, the server device 30 includes a communicator 31, a notifier 32, a controller 300, and a storage 350. The communicator 31 includes, for example, a communication circuit or a communication module and transmits and receives various types of information to and from the liquid supply device 10 via the network NW.

The notifier 32 is, for example, implemented by a display, a speaker, or the like. Hereafter, a description will be given of the case where the notifier 32 is implemented by a display. The notifier 32 displays an image of various types of information on a display based on control of the controller 300 to notify the administrator of the server device 30 of the various types of information.

The controller 300 is, for example, implemented by a hardware processor, such as a central processing unit (CPU), executing a program (software). In addition, some or all of these components may be implemented by hardware (including circuitry) such as LSI, an ASIC, a FPGA, and a GPU or may be implemented by software and hardware cooperating each other. The program may be stored in advance in the storage 350 including a non-transitory storage medium, such as an HDD or flash memory. The storage 350 may be implemented by various storage media mentioned above, or EEPROM, ROM, RAM or the like.

The controller 300 includes, for example, a notification controller 301. The notification controller 301 causes the notifier 32 to issue a notification of various types of information based on information received from the liquid supply device 10. Specifically, when the information, which indicates a determination result, received from the liquid supply device 10 indicates that the storage amount of ink capable of being supplied via the liquid supply path 11 from the liquid container TK is less than or equal to the predetermined lower limit, the notification controller 301 causes the notifier 32 to issue a notification of information indicating that refilling with ink is desired.

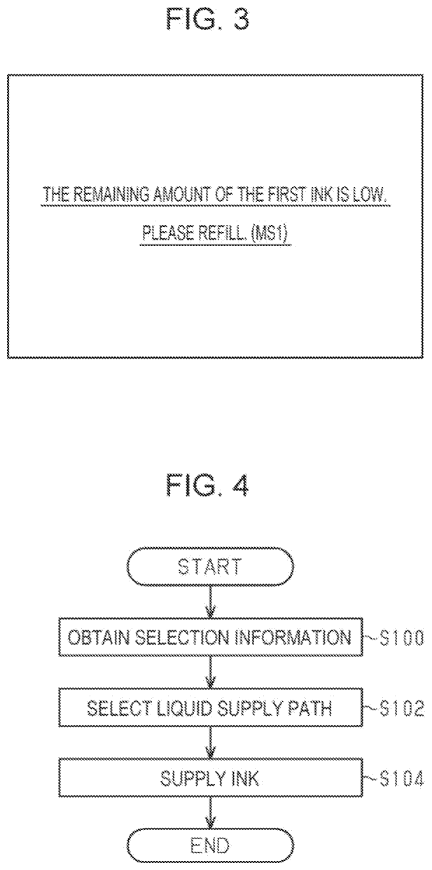

As illustrated in FIG. 3, the notification controller 301 causes the notifier 32 to display an image including a message MS1 representing, based on a determination result, that the remaining amount of ink is low and refilling with ink is desired. Thereby, the notifier 32 issues a notification to the administrator of the server device 30. The message MS1 is, for example, a message stating “The remaining amount of the first ink is low. Please refill.”, which includes the type of ink included in a determination result indicating a predetermined lower limit.

### Operations of Liquid Supply System 1

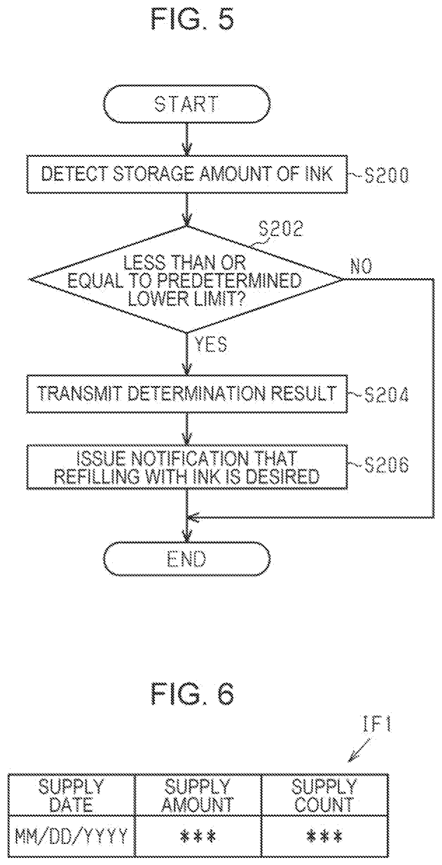

With reference to FIG. 4 and FIG. 5, operations of the liquid supply system 1 according to the embodiment will be described hereafter. The process illustrated in the flowchart in FIG. 4 is executed, for example, at a timing at which the obtainer 101 obtains information from the touch panel 18 or the imager 19. Regarding the steps performed by the controller 100, a description will be given hereafter such that the obtainer 101, the selector 102, the supply controller 103, and the determiner 104, which are functional components of the controller 100, are the subjects. In addition, regarding steps performed by the controller 300, a description will be given hereafter such that the notification controller 301, which is a functional component of the controller 300, is the subject.

As illustrated in FIG. 4, first, at step S100, the obtainer 101 obtains selection information used for selection of the type of the cartridge CR from the touch panel 18 or the imager 19. Specifically, the obtainer 101 obtains, as the selection information, information indicating operations of the user from the touch panel 18. The obtainer 101 also obtains, as the selection information, information indicating an image captured by the imager 19.

Then, at step S102, the selector 102 selects any one of the liquid supply paths 11 based on the selection information obtained by the obtainer 101. The selector 102 selects the liquid supply path 11, for example, based on the selection information indicating an operation of the user input to the touch panel 18. Specifically, in accordance with an operation of selecting the type of the cartridge CR, the selector 102 selects the liquid supply path 11 corresponding to ink to be contained in the cartridge CR selected by the operation. In addition, the selector 102 selects the liquid supply path 11 corresponding to ink to be contained in the cartridge CR by reading a two-dimensional barcode indicated in an image generated by the imager 19.

Then, at step S104, in accordance with a selection result of the selector 102, the supply controller 103 supplies ink via the selected liquid supply path 11 to the cartridge CR. Specifically, the supply controller 103 opens the on-off valve 15 in the liquid supply path 11 selected by the selector 102 and closes the other on-off valves 15. The supply controller 103 supplies ink contained in the liquid container TK to the injecting portion 13 via the selected liquid supply path 11 by operating the pump 16.

The process illustrated in the flowchart in FIG. 5 is executed, for example, at predetermined time intervals. As illustrated in FIG. 5, first, at step S200, the detector 14 detects the storage amount of ink capable of being supplied via the liquid supply path 11 from the liquid container TK. The detector 14 outputs information indicating the detected storage amount of ink to the controller 100.

Then, at step S202, the determiner 104 determines, based on a detection result of the detector 14, whether the storage amount of ink capable of being supplied via the liquid supply path 11 from the liquid container TK is less than or equal to a predetermined lower limit. For each of the detection results of the detectors 14-1 to 14-4, the determiner 104 determines whether the storage amount of ink capable of being supplied from the liquid container TK is less than or equal to the predetermined lower limit.

Then, at step S204, the determiner 104 causes the communicator 110 to transmit information indicating a determination result to the server device 30. The information indicating a determination result includes, for example, a determination result and information indicating the type of ink related to the determination result. The information indicating the type of ink is information indicating, for example, the first to fourth inks.

Then, at step S206, the notification controller 301 causes the notifier 32 to issue a notification of various types of information based on information received from the liquid supply device 10. Specifically, when the information, which indicates a determination result, received from the liquid supply device 10 indicates that the storage amount of ink capable of being supplied is less than or equal to the predetermined lower limit, the notification controller 301 causes the notifier 32 to issue a notification of information indicating that refilling with ink is desired.

### Operations and Advantages of First Embodiment

The operations and advantages described below are obtained in the liquid supply system 1 according to the present embodiment.

1-1. The liquid supply system 1 includes the selector 102 that selects any one of the liquid supply paths 11-1 to 11-4. The liquid supply system 1 includes a combination of the on-off valve 15-1 and the pump 16 and a combination of the on-off valve 15-2 and the pump 16. The liquid supply system 1 includes the notifier 32 that issues a notification of the storage amount of ink capable of being supplied via the liquid supply path 11 from the liquid container TK being less than or equal to the predetermined lower limit. When the liquid supply path 11-1 is selected by the selector 102, the on-off valve 15-1 and the pump 16 supply ink contained in the liquid container TK-1 via the liquid supply path 11-1 to the cartridge CR. When the liquid supply path 11-2 is selected by the selector 102, the on-off valve 15-2 and the pump 16 supply ink contained in the liquid container TK-2 via the liquid supply path 11-2 to the cartridge CR.

According to such a configuration, in using the component CR as a refill container, the liquid supply system 1 may supply appropriate ink corresponding to the cartridge CR. In addition, according to such a configuration, the liquid supply system 1 may notify that refilling with ink is desired.

1-2. The liquid supply path 11-1 may include the coupling portion 12-1, and the coupling portion 12-1 may couple the injecting portion 13-1 to the liquid supply path 11-1. The liquid supply path 11-2 may include the coupling portion 12-2, and the coupling portion 12-2 may couple the injecting portion 13-2 to the liquid supply path 11-2.

According to such a configuration, by using the coupling portion 12, the liquid supply device 10 may separate the coupling between the liquid supply path 11 and the injecting portion 13. Thereby, the liquid supply device 10 may facilitate replacement of the injecting portion 13.

1-3. All of the coupling portions 12-1 to 12-4 may have the same shape. According to such a configuration, when the injection coupling portions have the same shape, a plurality of types of injecting portions 13 in accordance with the types of cartridges CR may be coupled to the coupling portion 12. Thereby, when the injection coupling portions have the same shape, a plurality of types of injecting portions 13 in accordance with the types of cartridges CR may be shared.

1-4. The liquid supply device 10 may include the touch panel 18 as an operation unit. The selector 102 may select any one of the liquid supply paths 11-1 to 11-4 in response to an operation of the user on the touch panel 18. According to such a configuration, the liquid supply device 10 may supply ink desired by the user to the cartridge CR in response to an operation of the user.

1-5. The liquid supply device 10 may include the imager 19. The selector 102 may select any one of the liquid supply paths 11-1 to 11-4 in accordance with an image captured and generated by the imager 19. According to such a configuration, by using information added to the cartridge CR the image of which has been captured by the imager 19, the liquid supply device 10 may supply ink desired by the user to the cartridge CR.

### Second Embodiment

A second embodiment of a liquid supply device and a liquid supply system will be described hereafter with reference to the accompanying drawings. The configurations that are the same or similar to those in the embodiment described above are denoted by the same reference numerals and repetitive description is omitted.

In the embodiment described above, the case where the supply controller 103 supplies ink to the cartridge CR in accordance with a selection of the selector 102 has been described. In the second embodiment, a description will be given of the case where the supply controller 103 supplies ink to the cartridge CR in accordance with refill history information.

The cartridge CR according to the second embodiment includes, for example, an information storage that stores various types of information. The information storage is, for example, implemented by a customer service integrated circuit (CSIC) or the like. Hereafter, a description will be given of the case where the information storage included in the cartridge CR is a CSIC. Refill history information IF1 is stored in the CSIC of the cartridge CR. As illustrated in FIG. 6, the refill history information IF1 includes, for example, supply date information, supply amount information, and total supply count information. The supply date information is, for example, information indicating the supply date on which ink was last supplied to the cartridge CR. The supply amount information is, for example, information indicating an amount of ink supplied on the supply date. The total supply count information is, for example, information indicating a total supply count, which is the total number of times ink has been supplied to the cartridge CR.

The liquid supply device 10 includes, for example, a reader/writer unit that reads and writes the refill history information IF1 stored in the CSIC of the cartridge CR. The supply controller 103 determines, in accordance with the refill history information IF1 read out by the reader/writer unit, whether ink is to be supplied to the cartridge CR.

The supply controller 103 determines, for example, in accordance with the total supply count among the information included in the refill history information IF1, whether ink is to be supplied to the cartridge CR. Here, when ink supply is performed repeatedly, packing in the ink inlet of the cartridge CR deteriorates in some cases. When packing deteriorates, ink leakage might occur or ink might be unable to be appropriately supplied to a printing device in which the cartridge CR is installed. If the total supply count is greater than or equal to a predetermined count, assuming that packing has deteriorated, the supply controller 103 determines that ink is not to be supplied to the cartridge CR.

The supply controller 103 determines, for example, in accordance with the supply date among the information included in the refill history information IF1, whether ink is to be supplied to the cartridge CR. Here, ink remaining in the cartridge CR may be left unattended for a long time. In this case, even if new ink is supplied to the cartridge CR, the remaining ink affects the new ink and thereby the printing quality may be degraded. If a predetermined period of time has elapsed since the supply date, the supply controller 103 assumes that the printing quality would be degraded, and determines that the ink is not to be supplied to the cartridge CR.

In addition, if the supply controller 103 determines that ink is to be supplied to the cartridge CR, the supply controller 103 supplies ink to the cartridge CR in accordance with information indicating the amount of ink supplied among the information included in the refill history information IF1. Specifically, the supply controller 103 supplies ink in an amount equal to or substantially equal to the amount of ink supplied, which is indicated in the refill history information IF1, to the cartridge CR. Thereby, the supply controller 103 may supply an appropriate amount of ink to the cartridge CR as before.

In accordance with supply of ink to the cartridge CR performed this time by the supply controller 103, the reader/writer unit updates the refill history information IF1. The reader/writer unit updates, for example, among the refill history information IF1, the information indicating the supply date on which ink was last supplied to the cartridge CR, and the information indicating the total supply count, and writes the updated information items to the CSIC of the cartridge CR. If ink is not supplied to the cartridge CR by the supply controller 103, the reader/writer unit may not update the refill history information IF1.

### Operations of Liquid Supply System 1

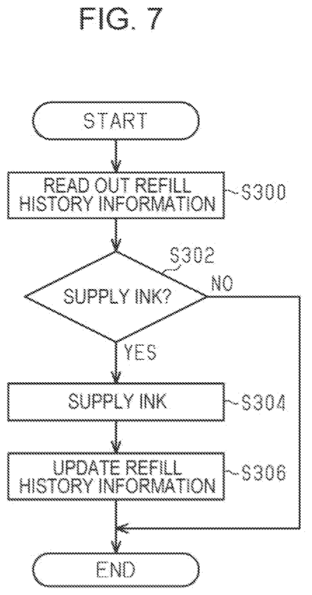

With reference to FIG. 7, operations of the liquid supply system 1 according to the second embodiment will be described hereafter. The process illustrated in the flowchart in FIG. 7 is executed, for example, instead of step S104, after step S102 of the flowchart illustrated in FIG. 4 described above.

First, at step S300, the reader/writer unit reads out the refill history information IF1 from the CSIC in the cartridge CR. Then, at step S302, the supply controller 103 determines, in accordance with the refill history information IF1, whether ink is to be supplied to the cartridge CR. If the total supply count is greater than or equal to the predetermined count, the supply controller 103 determines that ink is not to be supplied to the cartridge CR. In addition, if the predetermined period of time has elapsed since the supply date, the supply controller 103 determines that ink is not to be supplied to the cartridge CR. If the supply controller 103 determines that ink is not to be supplied to the cartridge CR, the supply controller 103 does not supply ink to the cartridge CR and terminates the process.

Then, if the supply controller 103 determines that ink is to be supplied to the cartridge CR, at step S304, the supply controller 103 supplies ink to the cartridge CR via the selected liquid supply path 11. Specifically, the supply controller 103 opens the on-off valve 15 in the liquid supply path 11 selected by the selector 102 and closes the other on-off valves 15. The supply controller 103 supplies ink contained in the liquid container TK to the injecting portion 13 via the selected liquid supply path 11 by operating the pump 16.

Then, at step S306, in accordance with processing at step S304 performed by the supply controller 103, the reader/writer unit updates the refill history information IF1 and writes it to the CSIC in the cartridge CR.

### Operations and Advantages of Second Embodiment

The operations and advantages described below are obtained in the liquid supply system 1 according to the present embodiment.

2-1. The supply controller 103 supplies ink to the cartridge CR in accordance with the refill history information IF1. According to such a configuration, the liquid supply device 10 may supply ink only to the cartridge CR appropriate for use as a refill container in accordance with the refill history information IF1.

### Third Embodiment

A third embodiment of a liquid supply device and a liquid supply system will be described hereafter with reference to the accompanying drawings. The configurations that are the same or similar to those in the embodiments described above are denoted by the same reference numerals and repetitive description is omitted.

In the second embodiment, the case where the supply controller 103 supplies ink to the cartridge CR in accordance with the refill history information IF1 has been described. In the third embodiment, a description will be given of the case where, for example, the supply controller 103 performs processing other than supplying ink to the cartridge CR in accordance with the refill history information IF1.

In the third embodiment, the supply controller 103 determines, in accordance with the supply date among the refill history information IF1, whether ink remaining in the cartridge CR is to be sucked. As described above, when ink remaining in the cartridge CR is left unattended for a long time, even if new ink is supplied to the cartridge CR, the remaining ink affects the new ink and thereby the printing quality may be degraded. If a predetermined period of time has elapsed since the supply date, the supply controller 103 determines that the remaining ink is to be sucked. In this case, the liquid supply device 10 includes a waste liquid container, a waste liquid flow channel coupled to the waste liquid container, and a switcher that switches coupling between each liquid supply path 11 and the waste liquid flow channel. The waste liquid container, the waste liquid flow channel, and the switcher are downstream of the on-off valve 15 in the liquid supply path 11. In performing suction of ink, the supply controller 103 switches the switcher to establish coupling between the liquid supply path 11 to which the cartridge CR is coupled, and the waste liquid flow channel. The supply controller 103 also closes all the on-off valves 15. In performing suction of ink, the supply controller 103 controls the pump 16 to cause a negative pressure to act on the liquid supply path 11 to which the cartridge CR is coupled, for a predetermine period of time. Thereby, the waste liquid container may contain ink remaining in the cartridge CR. The predetermined period of time is, for example, a time taken to suck all the ink capable of being contained in the cartridge CR.

### Operations of Liquid Supply System 1

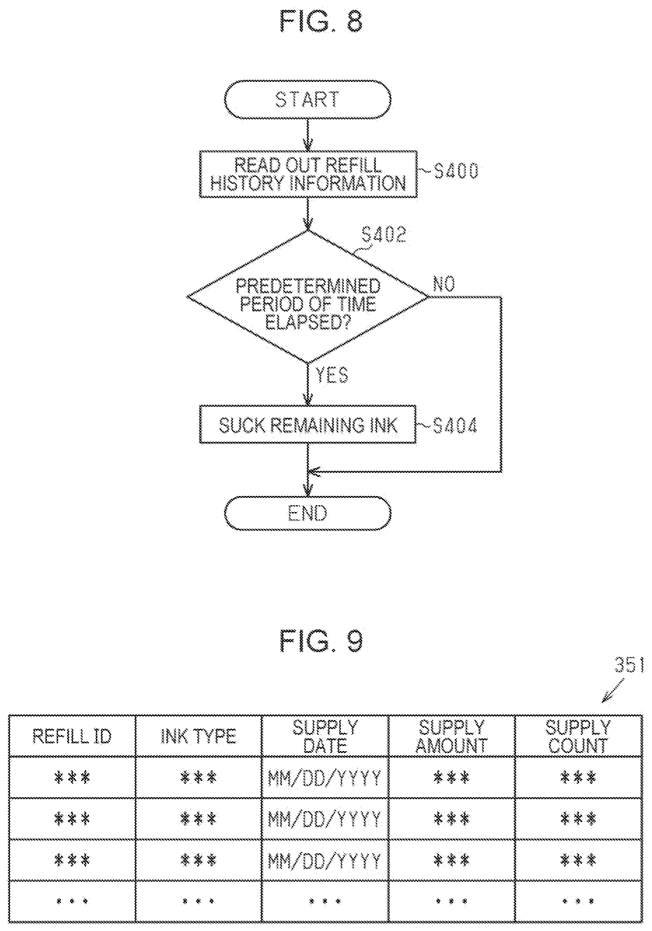

With reference to FIG. 8, another example of operations of the liquid supply system 1 according to the third embodiment will be described hereafter. The process illustrated in the flowchart in FIG. 8 is executed, for example, prior to execution of the flowchart illustrated in FIG. 4 described above or prior to execution of the flowchart illustrated in FIG. 7 described above.

First, at step S400, the reader/writer unit reads out the refill history information IF1 from the CSIC in the cartridge CR. Then, at step S402, the supply controller 103 determines, in accordance with the supply date among the information included in the refill history information IF1, whether ink remaining in the cartridge CR is to be sucked. Specifically, if a predetermined period of time has elapsed since the supply date, the supply controller 103 determines that the remaining ink is to be sucked. If the supply controller 103 determines that the remaining ink is not to be sucked, the supply controller 103 terminates the process.

Then, at step S404, if the supply controller 103 determines that the remaining ink is to be sucked, the supply controller 103 controls components included in the liquid supply device 10 so that the remaining ink is sucked and then is contained in the waste liquid container included in the liquid supply device 10. Specifically, in performing suction, the supply controller 103 controls the on-off valve 15, the pump 16, and the switcher to cause the remaining ink to be sucked and then contained in the waste liquid container.

### Operations and Advantages of Third Embodiment

The operations and advantages described below are obtained in the liquid supply system 1 according to the present embodiment.

3-1. The supply controller 103 performs suction of ink remaining in the cartridge CR in accordance with the refill history information IF1. According to such a configuration, the liquid supply device 10 may supply ink after the cartridge CR in use as a refill container has been put in the appropriate state in accordance with the refill history information IF1.

### Fourth Embodiment

A fourth embodiment of a liquid supply device and a liquid supply system will be described hereafter with reference to the accompanying drawings. The configurations that are the same or similar to those in the embodiments described above are denoted by the same reference numerals and repetitive description is omitted.

The description has been given above of the case where the refill history information IF1 is stored in the CSIS of the cartridge CR. In the fourth embodiment, a description will be given of the case where the refill history information 351 is stored in the storage 350 of the server device 30.

In the fourth embodiment, identification information by which the cartridge CR is able to be identified is stored instead of (or in addition to) the refill history information IF1 in the CSIS of the cartridge CR. The identification information of the cartridge CR will be described hereafter as a refill ID. The reader/writer unit reads out the refill ID stored in the CSIS. The supply controller 103 causes the communicator 110 to transmit information indicating the read-out refill ID to the server device 30.

As illustrated in FIG. 9, the refill history information 351 includes one or more records in each of which, for example, the refill ID, the ink type information, the supply date information, the supply amount information, and the total supply count information are associated with each other. The ink type information is, for example, information indicating the type of ink that is supplied to the cartridge CR having the associated refill ID.

The controller 300 searches the refill history information 351 based on the refill ID received from the liquid supply device 10. The controller 300 searches the refill history information 351 using the refill ID as a search key to identify a record associated with the refill ID. The controller 300 causes the communicator 31 to transmit information indicating the identified record to the liquid supply device 10.

The supply controller 103 performs the process of the flowchart illustrated in FIG. 7 and the process of the flowchart illustrated in FIG. 8 in accordance with the record received from the server device 30. The details of the processes performed by the supply controller 103 are omitted because the processes are the same or similar to the processes described above.

In accordance with supply of ink to the cartridge CR performed this time, the supply controller 103 causes the communicator 31 to transmit information for use for update of the refill history information 351 to the liquid supply device 10. The information for use for update of the refill history information 351 is, for example, the refill ID, the information indicating the supply date on which ink was last supplied to the cartridge CR, and the information indicating the amount of ink supply on the supply date. In accordance with information received from the liquid supply device 10, the controller 300 updates, among the records included in the refill history information 351, a record with which the same refill ID is associated. Thereby, the controller 300 updates the refill history information 351. If supply of ink to the cartridge CR is not performed by the supply controller 103, the refill history information 351 may not be updated.

### Operations and Advantages of Fourth Embodiment

The operations and advantages described below are obtained in the liquid supply system 1 according to the present embodiment.

4-1. The refill history information 351 is stored in the storage 350 of the server device 30. According to such a configuration, the server device 30 may centrally manage the history of refills performed in the liquid supply system 1 using the refill history information 351. In addition, a cartridge provider and an ink refill operator may grasp the use tendency and use amount of ink of the user by referring to the refill history information 351.

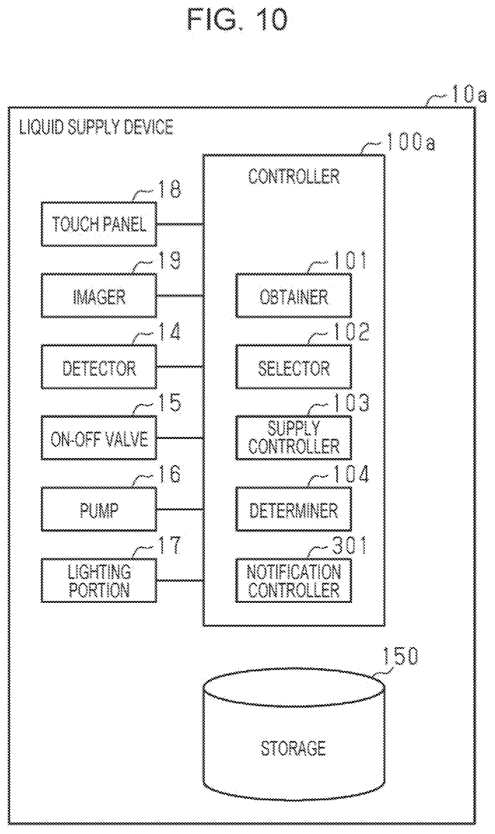

The present embodiment may be modified as follows to be performed. The present embodiment and the following modifications may be performed in combination with each other as long as any technological contradiction does not arise.
Information included in the refill history information IF1 and in the refill history information 351 is exemplary and is not limited to this. The refill history information IF1 and the refill history information 351 may each be information including some of the information described above. In addition, the refill history information IF1 may include information other than the information mentioned above.
The refill history information IF1 and the refill history information 351 may include information indicating the manufacture date of the cartridge CR. In this case, if a predetermined period of time has elapsed since the manufacture date, assuming that packing has deteriorated, the supply controller 103 may determine that ink is not to be supplied to the cartridge CR.
Although a description has been given above of the case where the liquid supply system 1 includes a single liquid supply device 10, the liquid supply system 1 is not limited to this. The liquid supply system 1 may include a plurality of liquid supply devices 10.
The liquid supply device 10 may be a device that supplies four or less types of ink or may be a device that supplies four or more types of ink as long as the liquid supply device 10 is capable of supplying a plurality of types of ink.
The liquid supply device 10 may include the liquid container TK. In this case, the liquid container TK may be directly coupled to the liquid supply path 11 of the liquid supply device 10 or, as described above, may be coupled via the arming members to the liquid supply device 10 to be removable from the liquid supply device 10. In addition, the liquid supply device 10 may include the injecting portion 13. In this case, the injecting portion 13 may be directly coupled to the liquid supply path 11 of the liquid supply device 10 or, as described above, may be coupled via the coupling portion 12 to the liquid supply device 10 to be removable from the liquid supply device 10.
The liquid supply device 10 may include a plurality of pumps 16 the number of which corresponds to the number of the liquid supply paths 11. In this case, the pump 16 is provided on each of the liquid supply paths 11. In accordance with the selection of the selector 102, the supply controller 103 controls the corresponding on-off valve 15 and pump 16.
On the liquid supply path 11, the pump 16 may be upstream of the on-off valve 15. In this case, the pump 16 and the on-off valve 15 are arranged in this order from the upstream on the liquid supply path 11.
When the liquid supply system 1 includes a plurality of liquid supply devices 10, information indicating a determination result may include information by which the liquid supply device 10 is able to be identified. The notification controller 301 refers to a database representing detailed information on each of the liquid supply devices 10. This database includes, for example, information by which the liquid supply device 10 is able to be identified, information about an installation location of the liquid supply device 10, the type of the cartridge CR to be handled by the liquid supply device 10, and an ink refill operator who is in charge of the liquid supply device 10. The notification controller 301 identifies the installation location of the liquid supply device 10, for example, based on the information indicating a received determination result and the database representing detailed information on the liquid supply device 10. The notification controller 301 causes the notifier 32 to issue a notification of the identified information included in the message MS1. Thereby, the administrator of the server device 30 may easily verify the liquid supply device 10 for which refilling with ink is desired.
Only when it is determined that the storage amount of ink capable of being supplied via the liquid supply path 11 from the liquid container TK is less than or equal to the predetermined lower limit, the determiner 104 may cause the communicator 110 to transmit information indicating a determination result to the server device 30. In addition, the predetermined lower limit may include “0”.
When the total supply count is greater than or equal to the predetermined count and when the predetermined period of time has elapsed since the supply date, the determiner 104 may determine that ink is not to be supplied to the cartridge CR. In addition, either when total supply count is greater than or equal to the predetermined count or when the predetermined period of time has elapsed since the supply date, the determiner 104 may determine that ink is not to be supplied.
The predetermined count used for determination of the determiner 104 may be the count that differs in accordance with the type of the cartridge CR. In addition, the predetermined period of time used for determination of the determiner 104 may be a period of time that differs in accordance with the type of the cartridge CR.
The liquid supply path 11 may not include the coupling portion 12. In this case, the injecting portion 13 is disposed at an end downstream of the liquid supply path 11. Thereby, when replacement of the injecting portion 13 is unnecessary, such as when the type of ink to be supplied and the corresponding cartridge CR are permanent in the liquid supply device 10, the configuration of the liquid supply path 11 may be simplified.
The coupling portions 12 may not have the same shape. For example, some of the coupling portions 12-1 to 12-4 may have the same shape or may have shapes different from each other. In this case, the cartridge provider may manufacture the injecting portions 13 tailored to his own design specifications.
Although a description has been given of the case where the detector 14 detects the weight of the liquid container TK, the detector 14 is not limited to this. The detector 14 may detect the remaining amount of a liquid contained in the liquid container TK, for example, by detecting the pressure in the liquid supply path 11 coupled to the liquid container TK. The detector 14 may detect the remaining amount of a liquid contained in the liquid container TK, for example, by detecting the liquid surface in the liquid container TK. Examples of a method for detecting the liquid surface in the liquid container TK include a method using an electrode and a method using a prism.
The detector 14 may be provided in the liquid container TK. In this case, the liquid supply device 10 and the detector 14 perform communication wirelessly or in a wired manner and the detector 14 outputs information indicating a detection result to the liquid supply device 10.
The supply controller 103 may determine, in accordance with information other than the control information stored in the storage 150, the amount of ink to be supplied to the cartridge CR. The supply controller 103 may appropriately correct the amount of ink to be supplied to the cartridge CR, for example, in accordance with the remaining amount of ink contained in the liquid container TK instead of (or in addition to) the control information. For example, although the amount of supplied ink indicated by the control information and the remaining amount of ink contained in the liquid container TK are approximately the same, the remaining amount of ink is lower in some cases. In this case, the supply controller 103 may control the components so that ink the amount of which is lower than the amount of supplied ink indicated by the control information.
The supply controller 103 may perform suction of the ink remaining in the cartridge CR only when the user approves the suction. In this case, if the supply controller 103 determines, in accordance with the refill history information IF1 and the refill history information 351, that a predetermined period of time has elapsed since the supply date, the touch panel 18 displays an image that prompts the user to select whether suction of ink is to be performed. In accordance with an operation of the user received by the touch panel 18, the supply controller 103 performs suction of ink. Specifically, when the touch panel 18 receives an approval operation of the user for performing suction of ink, the supply controller 103 performs suction of ink.
If the selector 102 obtains information from both of the touch panel 18 and the imager 19, the selector 102 may select the liquid supply path 11 only when the liquid supply path 11 indicated by the information obtained from the touch panel 18 matches the liquid supply path 11 based on an image generated by the imager 19.
The selector 102 may select the liquid supply path 11 in accordance with an operation of the user that is based on an image generated by the imager 19 and that is input to the touch panel 18. In this case, first, the imager 19 captures the cartridge CR to generate an image. The selector 102 identifies the type of the cartridge CR based on an image generated by the imager 19. The selector 102 causes the touch panel 18 to display an image that prompts the user to select whether ink is to be supplied to the cartridge CR of the identified type. Examples of the image that the selector 102 causes the touch panel 18 to display include a message such as “Is this your cartridge?” an image of the identified cartridge CR, an image of information regarding the identified cartridge CR, and an image of receiving a selection operation of the user, such as “Yes” and “No”. The selector 102 selects the liquid supply path 11 in accordance with information indicating an operation of the user input to the touch panel 18.
The liquid supply device 10 may include a reader of a radio frequency identification (RFID) tag instead of (or in addition to) the imager 19. In this case, the RFID tag is added to the cartridge CR. Information indicating the type of ink contained in the cartridge CR is stored in the RFID tag. The reader reads the RFID tag to obtain information indicating the ink type. The selector 102 selects the liquid supply path 11 corresponding to the ink type in accordance with the information indicating the ink type obtained by the reader.
Although a description has been given of the case where the selector 102 selects the liquid supply path 11 corresponding to ink to be contained in the cartridge CR by reading a two-dimensional barcode indicated in an image generated by the imager 19, the selector 102 is not limited to this. The selector 102 may perform image processing on an image generated by the imager 19 to identify characters that are added to the cartridge CR and that represent the ink type, instead of (or in addition to) the two-dimensional barcode. The selector 102 selects the liquid supply path 11 corresponding to ink to be contained in the cartridge CR based on the identified ink type.
Although a description has been given of the case where the server device 30 includes the notifier 32, the server device 30 is not limited to this. The liquid supply device 10 may include, for example, functions included in the server device 30, such as the notifier 32. As illustrated in FIG. 10, the liquid supply device 10a includes, for example, a controller 100a instead of the controller 100 included in the liquid supply device 10. The controller 100a includes a notification controller 301 in addition to the configuration included in the controller 100. In this case, the notification controller 301 causes the touch panel 18 serving as a notifier to issue a notification of various types of information. Specifically, the notification controller 301 notifies the administrator of the server device 30 based on a determination result by causing the touch panel 18 to display an image of the message MS1 representing that the remaining amount of ink is low and refilling is desired. In this case, the liquid supply system 1 may not include the server device 30. According to such a configuration, the liquid supply system 1 may notify that refilling with ink is desired.
Instead of (or in addition to) the touch panel 18 constructed integrally with the display unit such as a display, the liquid supply device 10 may discretely include a display unit serving as the notifier and an operation unit. In this case, the display unit is implemented by a display or the like and the operation unit is implemented by a touch panel, buttons, or the like.
The liquid supply device 10 may include one of the touch panel 18 serving as the operation unit and the imager 19. In addition, the liquid supply device 10 may include an operation unit in another manner instead of (or in addition to) the touch panel 18 serving as the operation unit. The operation unit in another manner may be, for example, operation buttons or the like corresponding to the types of the cartridges CR handled by the liquid supply device 10. In this case, the selector 102 selects the liquid supply path 11 in accordance with a button depressed by the user.
In addition, the liquid supply device 10 may not include the touch panel 18 serving as the operation unit and the imager 19. In this case, the liquid supply device 10 includes a detector that detects the pressure of the liquid supply path 11 instead of the touch panel 18 serving as the operation unit and the imager 19. For example, the selector 102 identifies the liquid supply path 11 for which the cartridge CR is installed in the injecting portion 13 by the user, based on a detection result of the detector, and selects the identified liquid supply path 11.
The liquid supply system 1 may not include the notification controller 301, the notifier 32, and the touch panel 18 serving as an operation unit. In this case, the ink refill operator may refill the liquid container TK with ink at every reference refill period. The reference refill period is, for example, a period of time during which the storage amount of ink capable of being supplied via the liquid supply path 11 from the liquid container TK does not reach less than or equal to a predetermined lower limit.
The notifier 32 may be implemented by a speaker that outputs sound of the message MS1. In addition, the liquid supply device 10a may include, as a notifier, a speaker that outputs sound of the message MS1. The notifier 32 may be implemented by a speaker that outputs sound indicating that refilling is desired. In addition, the liquid supply device 10 may include, as a notifier, a speaker that outputs sound indicating that refilling is desired. The notifier 32 may be implemented by an LED that uses light to notify that refilling is desired. In addition, the liquid supply device 10 may turn on the lighting portion 17 serving as a notifier in a manner different from that in turning on the lighting portion 17 for ink supply, so that a notification that refilling is desired is issued by light.
In addition, the communicator 110 or a terminal device with which the communicator 31 communicates may operate as a notifier. In this case, the liquid supply device 10, the liquid supply device 10a, or the server device 30 is connected to a terminal device used by the ink refill operator via the network NW so as to be capable of transmitting and receiving information to and from the terminal device. The notification controller 301 issues a notification by transmitting information, which indicates that refilling with ink is desired, to the terminal device of an ink refill operator who is in charge of the liquid supply device 10 for which refilling is desired. Thereby, the ink refill operator may grasp that refilling with ink is desired. In this case, the terminal device of the ink refill operator is an example of the notifier.
Although a description has been given of the case where the injecting portion 13 is provided in an upper portion of the opening HL2 in the front of the liquid supply device 10, the injecting portion 13 is not limited to this. Among the injecting portions 13, only the injecting portion 13 corresponding to the liquid supply path 11 selected by the selector 102 may be provided in the upper portion of the opening HL2.

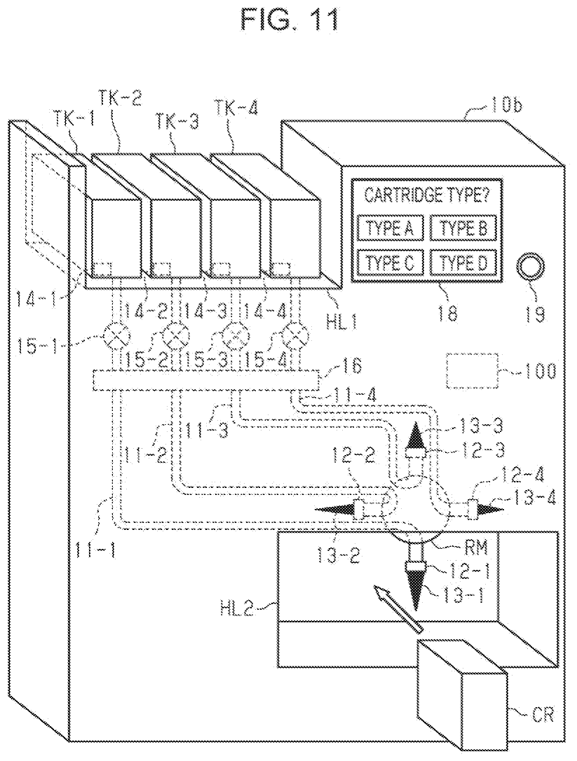

As illustrated in FIG. 11, the liquid supply device 10b includes a rotation mechanism RM in addition to the configuration included in the liquid supply device 10 or the liquid supply device 10a. The rotation mechanism RM has a circular cylindrical shape and is disposed such that the top surface or bottom surface is parallel to the front face of the liquid supply device 10b. The rotation mechanism RM rotates around the rotation axis passing through the center of the top surface and the center of the bottom surface based on control of the controller 100.

The injecting portions 13-1 to 13-4 are disposed on the side surface of the rotation mechanism RM. Any one of the injecting portions 13-1 to 13-4 is positioned at an upper portion of the opening HL2 as the rotation mechanism RM rotates. The controller 100 rotates the rotation mechanism RM, for example, in accordance with a selection result of the selector 102, such that the injecting portion 13 corresponding to the selection result is located in the upper portion of the opening HL2. Thereby, the liquid supply device 10b enables the user to uniquely identify the injecting portion 13 that receives ink supply. In addition, the liquid supply device 10b enables the user to be less likely to insert, into the cartridge CR, the injecting portion 13 different from the injecting portion 13 corresponding to his cartridge CR.

Technical ideas understood from the embodiments and modifications described above and the operations and advantages will be described hereafter.

A. A liquid supply device includes a first liquid supply path that supplies a printing liquid contained in a first liquid container to a first liquid supply port corresponding to a type of a container, a second liquid supply path that supplies a printing liquid contained in a second liquid container to a second liquid supply port corresponding to a type of the container, a selector that selects either the first liquid supply path or the second liquid supply path, and a liquid supplier that, when the first liquid supply path is selected by the selector, supplies the printing liquid contained in the first liquid container via the first liquid supply path to the container and that, when the second liquid supply path is selected by the selector, supplies the printing liquid contained in the second liquid container via the second liquid supply path to the container.

According to this configuration, in using a container as a refill container, the liquid supply device may supply an appropriate printing liquid corresponding to the container.

B. In the liquid supply device mentioned above, the first liquid supply path may include a first coupling portion, the first coupling portion may couple the first liquid supply port to the first liquid supply path, the second liquid supply path may include a second coupling portion, and the second coupling portion may couple the second liquid supply port to the second liquid supply path.

According to this configuration, the liquid supply device may separate the coupling between the first liquid supply path and the first liquid supply port by using the first coupling portion and may separate the coupling between the second liquid supply path and the second liquid supply port by using the second coupling portion. Thereby, the liquid supply device may facilitate replacement of the first liquid supply port and the second liquid supply port.

C. In the liquid supply device mentioned above, the first coupling portion and the second coupling portion may have the same shape.

According to this configuration, a plurality of types of liquid supply ports in accordance with the types of containers may be coupled to the coupling portions when the coupling portions have the same shape. Thereby, a plurality of types of liquid supply ports in accordance with the types of containers may be shared when the coupling portions have the same shape.

D. The liquid supply device mentioned above may further include a first detector that detects a storage amount of the printing liquid capable of being supplied via the first liquid supply path from the first liquid container, a second detector that detects a storage amount of the printing liquid capable of being supplied via the second liquid supply path from the second liquid container, a determiner that determines whether the storage amount of the printing liquid capable of being supplied via the first liquid supply path from the first liquid container is less than or equal to a predetermined lower limit, and that determines whether the storage amount of the printing liquid capable of being supplied via the second liquid supply path from the second liquid container is less than or equal to the predetermined lower limit, and a notifier that issues, based on a determination result of the determiner, a notification indicating either that the storage amount of the printing liquid capable of being supplied via the first liquid supply path from the first liquid container is less than or equal to the predetermined lower limit or that the storage amount of the printing liquid capable of being supplied via the second liquid supply path from the second liquid container is less than or equal to the predetermined lower limit.

According to this configuration, the liquid supply device may notify that refilling with a printing liquid is desired.

E. The liquid supply device mentioned above may further include an operation unit, and, in this liquid supply device, the selector may select either the first liquid supply path or the second liquid supply path in accordance with an operation of the operation unit.

According to this configuration, the liquid supply device may supply a printing liquid desired by the user to the container in response to an operation of the user.

F. The liquid supply device mentioned above may further include an imager, and, in this liquid supply device, the selector selects either the first liquid supply path or the second liquid supply path in accordance with an image captured and generated by the imager.

According to this configuration, the liquid supply device may supply a printing liquid desired by the user to a container in accordance with information added to the container the image of which has been captured by the imager.

G. A liquid supply system includes a first liquid supply path that supplies a printing liquid contained in a first liquid container to a first liquid supply port corresponding to a type of a container, a second liquid supply path that supplies a printing liquid contained in a second liquid container to a second liquid supply port corresponding to a type of the container, a selector that selects either the first liquid supply path or the second liquid supply path, a liquid supplier that, when the first liquid supply path is selected by the selector, supplies the printing liquid contained in the first liquid container via the first liquid supply path to the container and that, when the second liquid supply path is selected by the selector, supplies the printing liquid contained in the second liquid container via the second liquid supply path to the container, a first detector that detects a storage amount of the printing liquid capable of being supplied via the first liquid supply path from the first liquid container, a second detector that detects a storage amount of the printing liquid capable of being supplied via the second liquid supply path from the second liquid container, a determiner that determines whether the storage amount of the printing liquid capable of being supplied via the first liquid supply path from the first liquid container is less than or equal to a predetermined lower limit, and that determines whether the storage amount of the printing liquid capable of being supplied via the second liquid supply path from the second liquid container is less than or equal to the predetermined lower limit; and a notifier that issues, based on a determination result of the determiner, a notification indicating either that the storage amount of printing liquid capable of being supplied via the first liquid supply path from the first liquid container is less than or equal to the predetermined lower limit or that the storage amount of print liquid capable of being supplied via the second liquid supply path from the second liquid container is less than or equal to the predetermined lower limit.

According to this configuration, the liquid supply system may have advantageous effects that are the same or similar to the liquid supply device described in A and D mentioned above.

What is claimed is:

1. A liquid supply device comprising:
a first liquid supply path that supplies a printing liquid contained in a first liquid container to a first liquid supply port corresponding to a type of a container;
a second liquid supply path that supplies a printing liquid contained in a second liquid container to a second liquid supply port corresponding to a type of the container; a selector that selects either the first liquid supply path or the second liquid supply path; and
a liquid supplier that, when the first liquid supply path is selected by the selector, supplies the printing liquid contained in the first liquid container via the first liquid supply path to the container and that, when the second liquid supply path is selected by the selector, supplies the printing liquid contained in the second liquid container via the second liquid supply path to the container.

2. The liquid supply device according to claim 1, wherein
the first liquid supply path includes a first coupling portion,
the first coupling portion couples the first liquid supply port to the first liquid supply path,
the second liquid supply path includes a second coupling portion, and
the second coupling portion couples the second liquid supply port to the second liquid supply path.

3. The liquid supply device according to claim 2, wherein
the first coupling portion and the second coupling portion have the same shape.

4. The liquid supply device according to claim 1, further comprising:
a first detector that detects a storage amount of the printing liquid capable of being supplied via the first liquid supply path from the first liquid container;
a second detector that detects a storage amount of the printing liquid capable of being supplied via the second liquid supply path from the second liquid container;
a determiner that determines whether the storage amount of the printing liquid capable of being supplied via the first liquid supply path from the first liquid container is less than or equal to a predetermined lower limit, and that determines whether the storage amount of the printing liquid capable of being supplied via the second liquid supply path from the second liquid container is less than or equal to the predetermined lower limit; and
a notifier that issues, based on a determination result of the determiner, a notification indicating either that the storage amount of the printing liquid capable of being supplied via the first liquid supply path from the first liquid container is less than or equal to the predetermined lower limit or that the storage amount of the printing liquid capable of being supplied via the second liquid supply path from the second liquid container is less than or equal to the predetermined lower limit.

5. The liquid supply device according to claim 1,
further comprising an operation unit, wherein
the selector selects either the first liquid supply path or the second liquid supply path in accordance with an operation of the operation unit.

6. The liquid supply device according to claim 1,
further comprising an imager, wherein
the selector selects either the first liquid supply path or the second liquid supply path in accordance with an image captured and generated by the imager.

7. A liquid supply system comprising:
a first liquid supply path that supplies a printing liquid contained in a first liquid container to a first liquid supply port corresponding to a type of a container;
a second liquid supply path that supplies a printing liquid contained in a second liquid container to a second liquid supply port corresponding to a type of the container;
a selector that selects either the first liquid supply path or the second liquid supply path;
a liquid supplier that, when the first liquid supply path is selected by the selector, supplies the printing liquid contained in the first liquid container via the first liquid supply path to the container and that, when the second liquid supply path is selected by the selector, supplies the printing liquid contained in the second liquid container via the second liquid supply path to the container;
a first detector that detects a storage amount of the printing liquid capable of being supplied via the first liquid supply path from the first liquid container;
a second detector that detects a storage amount of the printing liquid capable of being supplied via the second liquid supply path from the second liquid container;
a determiner that determines whether the storage amount of the printing liquid capable of being supplied via the first liquid supply path from the first liquid container is less than or equal to a predetermined lower limit, and that determines whether the storage amount of the printing liquid capable of being supplied via the second liquid supply path from the second liquid container is less than or equal to the predetermined lower limit; and
a notifier that issues, based on a determination result of the determiner, a notification indicating either that the storage amount of printing liquid capable of being supplied via the first liquid supply path from the first liquid container is less than or equal to the predetermined lower limit or that the storage amount of print liquid capable of being supplied via the second liquid supply path from the second liquid container is less than or equal to the predetermined lower limit.
